(19) United States
(12) Patent Application Publication
(10) Pub. No.: US 2024/0413735 A1
(43) Pub. Date: Dec. 12, 2024

(54) SWITCHING CONVERTER WITH REDUCED POWER LOSS AND CONTROL METHOD THEREOF

(71) Applicant: Chengdu Monolithic Power Systems Co., Ltd., Chengdu (CN)

(72) Inventor: Guangzhuo Li, Hangzhou (CN)

(21) Appl. No.: 18/733,531

(22) Filed: Jun. 4, 2024

(30) Foreign Application Priority Data
Jun. 8, 2023 (CN) 202310676292.X

(51) Int. Cl. H02M 1/00; H02M 1/42; H02M 3/00; H02M 3/335; H02M 7/219

(52) U.S. Cl. CPC H02M 1/007; H02M 1/0009; H02M 1/0054; H02M 1/4233; H02M 3/01; H02M 3/33571; H02M 7/219

(57) ABSTRACT

A control method for a switching converter. The switching converter has a front stage circuit providing a first output voltage between a first node and a second node, a voltage dividing circuit coupled between the first node and a third node and a current sensing circuit coupled between the third node and the second node. The control method includes the following steps. Receiving a first voltage signal from an output terminal of the voltage dividing circuit. Receiving a second voltage signal from the third node. Generating a voltage sensing signal indicative of the first output voltage based on the first voltage signal and the second voltage signal. And generating a switch control signal to control the front stage circuit based on the voltage sensing signal and the second voltage signal.

### CROSS-REFERENCE TO RELATED APPLICATIONS

This application claims the benefit of CN application No. 202310676292.X, filed on Jun. 8, 2023, and incorporated herein by reference.

### TECHNICAL FIELD OF THE INVENTION

The present invention generally relates to electronic circuits, and more particularly but not exclusively, to switching converters and associated control methods.

### BACKGROUND OF THE INVENTION

Switching converters are employed in power supply circuits to provide a regulated output voltage to a load. In a two stage switching converter, a front stage circuit converts an input voltage into a bus voltage and a rear stage circuit provides an output voltage based on the bus voltage. In order to control the power switches of the two stage switching converter, perform over voltage protection and other functions, both the front stage circuit and the rear stage circuit are required to sense the bus voltage. However, how to sense the bus voltage for the front stage circuit and the rear stage circuit respectively becomes a challenge.

### SUMMARY OF THE INVENTION

An embodiment of the present invention discloses a switching converter including a front stage circuit, a voltage dividing circuit, a current sensing circuit, a rear stage circuit and a voltage sensing circuit. The front stage circuit is configured to generate a first output voltage between a first node and a second node. The voltage dividing circuit is coupled between the first node and a third node and configured to generate a first voltage signal at an output terminal of the voltage dividing circuit. The current sensing circuit is coupled between the third node and the second node. The rear stage circuit is coupled between the first node and the third node to receive a bus voltage and configured to convert the bus voltage into a second output voltage. The voltage sensing circuit is coupled to the output terminal of the voltage dividing circuit to receive the first voltage signal and coupled to the third node to receive a second voltage signal, where the voltage sensing circuit is configured to generate a voltage sensing signal indicative of the first output voltage based on the first voltage signal and the second voltage signal.

An embodiment of the present invention discloses a control circuit for a switching converter, where the switching converter has a front stage circuit providing a first output voltage between a first node and a second node, a voltage dividing circuit coupled between the first node and a third node and a current sensing circuit coupled between the third node and the second node. The control circuit includes a first pin, a second pin, a third pin, a fourth pin, a voltage sensing circuit and a switch control circuit. The first pin is configured to be coupled to an output terminal of the voltage dividing circuit to receive a first voltage signal. The second pin is configured to be coupled to the third node to receive a second voltage signal. The third pin is configured to provide a switch control signal to control the front stage circuit. The fourth pin is configured to be coupled to the second node and coupled to a reference ground of the control circuit The voltage sensing circuit is coupled to the first pin to receive the first voltage signal, coupled to the second pin to receive the second voltage signal and coupled to the fourth pin. The voltage sensing circuit is configured to generate a voltage sensing signal indicative of the first output voltage based on the first voltage signal and the second voltage signal. The switch control circuit is configured to receive the voltage sensing signal and the second voltage signal and to generate the switch control signal based on the voltage sensing signal and the second voltage signal.

An embodiment of the present invention discloses a control method for a switching converter, where the switching converter has a front stage circuit providing a first output voltage between a first node and a second node, a voltage dividing circuit coupled between the first node and a third node and a current sensing circuit coupled between the third node and the second node. The control method includes the following steps. 1) Receiving a first voltage signal from an output terminal of the voltage dividing circuit. 2) Receiving a second voltage signal from the third node. 3) Generating a voltage sensing signal indicative of the first output voltage based on the first voltage signal and the second voltage signal. And 4) generating a switch control signal to control the front stage circuit based on the voltage sensing signal and the second voltage signal.

### BRIEF DESCRIPTION OF DRAWINGS

The present invention can be further understood with reference to the following detailed description and the appended drawings, wherein like elements are provided with like reference numerals.

FIG. 1 illustrates a circuit schematic of a switching converter 100.

FIG. 2 illustrates a block diagram of a switching converter 200 in accordance with an embodiment of the present invention.

FIG. 3 illustrates a circuit schematic of a switching converter 200A in accordance with an embodiment of the present invention.

FIG. 4 illustrates working states of power switches S1^{˜}S4 in the front stage circuit 20A shown in FIG. 3 in accordance with an embodiment of the present invention.

FIG. 5 illustrates a circuit schematic of a switching converter 200B in accordance with another embodiment of the present invention.

FIG. 6 illustrates a flowchart of a control method 600 used in a switching converter in accordance with an embodiment of the preset invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

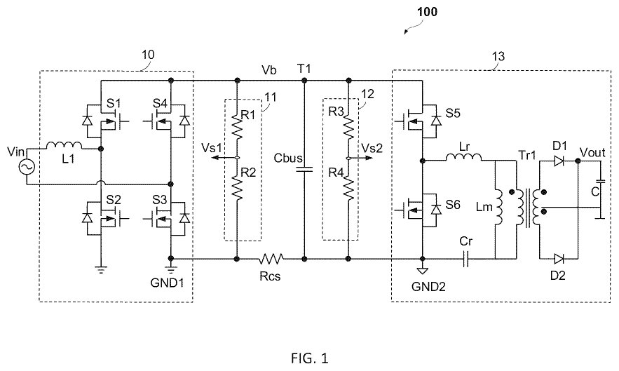

FIG. 1 illustrates a circuit schematic of a switching converter 100. The switching converter 100 includes a front stage circuit 10 and a rear stage circuit 13. The front stage circuit 10 generates a voltage Vb at a node T1 based on an input voltage Vin and the rear stage circuit 13 generates an output voltage Vout to power a load (not shown) based on the voltage Vb. There is a resistor Rcs coupled between the front stage circuit 10 and the rear stage circuit 13 and thus the two stage circuits are not common-grounded. For example, the front stage circuit 10 has a reference ground GND1, while the rear stage circuit 13 has a reference ground GND2. In the example shown in FIG. 1, in order to sense the voltage Vb for the front stage circuit 10 and the rear stage circuit 13 respectively, two different voltage dividing circuits are used. As shown in FIG. 1, a first voltage dividing circuit 11 is used to sense the voltage Vb for the front stage circuit 10 and a second voltage dividing circuit 12 is used to sense the voltage Vb for the rear stage circuit 13. However, this sensing method may lead to large power loss.

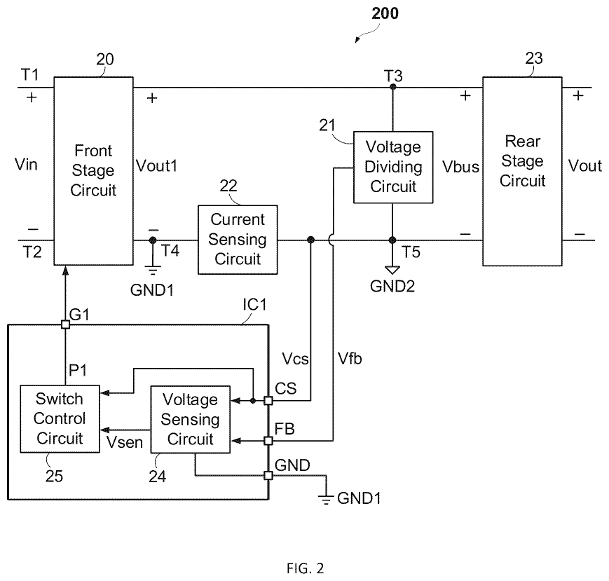

FIG. 2 illustrates a block diagram of a switching converter 200 in accordance with an embodiment of the present invention. As shown in FIG. 2, the switching converter 200 includes a front stage circuit 20, a voltage dividing circuit 21, a current sensing circuit 22 and a rear stage circuit 23.

The front stage circuit 20 is coupled between a node T1 and a node T2 to receive an input voltage Vin and configured to generate a first output voltage Vout1 between a node T3 and a node T4 based on the input voltage Vin.

The voltage dividing circuit 21 is coupled between the node T3 and a node T5 and configured to generate a first voltage signal Vfb at an output terminal of the voltage dividing circuit 21.

The current sensing circuit 22 is coupled between the node T5 and the node T4 and configured to generate a second voltage signal Vcs at the node T5. The current sensing circuit 22 is configured to sense a current flowing between the node T5 and the node T4 and the second voltage signal Vcs represents the current flowing between the node T5 and the node T4.

The rear stage circuit 23 is coupled between the node T3 and the node T5 to receive a bus voltage Vbus and configured to convert the bus voltage Vbus into a second output voltage Vout to power a load (not shown) based on the bus voltage Vbus.

In the example shown in FIG. 2, the node T4 is coupled to a reference ground GND1 of the front stage circuit 20 and the node T5 is coupled to a reference ground GND2 of the rear stage circuit 23.

In the example shown in FIG. 2, the voltage dividing circuit 21 and the rear stage circuit 23 are coupled in parallel between the node T3 and the node T5. The rear stage circuit 23 can sense the bus voltage Vbus by the voltage dividing circuit 21 directly. For example, the rear stage circuit 23 can sense the bus voltage Vbus based on the difference between the first voltage signal Vfb and the voltage at the node T5. In one embodiment, the first voltage signal Vfb indicates the bus voltage Vbus.

Those skilled in the art can understand that the rear stage circuit 23 may be omitted in other embodiments. In one embodiment, the load may be coupled between the node T3 and the node T5 and powered by the bus voltage Vbus directly.

The switching converter 200 further includes a voltage sensing circuit 24 and a switch control circuit 25. In the example shown in FIG. 2, the voltage sensing circuit 24 and the switch control circuit 25 are integrated in an integrated control circuit IC1. The integrated control circuit IC1 has a plurality of pins, including a pin FB for receiving feedback voltage information, a pin CS for receiving current information, a pin G1 for providing a switch control signal P1 to the front stage circuit 20 and a pin GND. The pin FB is coupled to the output terminal of the voltage dividing circuit 21 to receive the first voltage signal Vfb. The pin CS is coupled to the node T5 to receive the second voltage signal Vcs. The pin GND is coupled to the reference ground GND1 of the front stage circuit 20.

The voltage sensing circuit 24 has a first input terminal, a second input terminal, a reference ground terminal and an output terminal, where the first input terminal is coupled to the pin FB to receive the first voltage signal Vfb, the second input terminal is coupled to the pin CS to receive the second voltage signal Vcs and the reference ground terminal is coupled to the pin GND. Based on the first voltage signal Vfb and the second voltage signal Vcs, the voltage sensing circuit 24 is configured to generate a voltage sensing signal Vsen indicative of the first output voltage Vou1 at the output terminal. In one embodiment, the voltage sensing circuit 24 is configured to generate the voltage sensing signal Vsen based on the power operation of the front stage circuit 20. In one embodiment, when the front stage circuit 20 performs power operation, the voltage sensing circuit 24 generates the voltage sensing signal Vsen based on the difference between the first voltage signal Vfb and the second voltage signal Vcs; when the front stage circuit 20 stops power operation, the voltage sensing circuit 24 generates the voltage sensing signal Vsen based on the difference between the first voltage signal Vfb and the reference ground GND1.

In the embodiments of the present invention, the front stage circuit 20 performs power operation means that a power switch of the front stage circuit 20 performs switching so that energy can be transmitted from input terminals of the front stage circuit 20 to output terminals of the front stage circuit 20, in other words, energy can be transmitted from the input voltage Vin to the first output voltage Vout1; the front stage circuit 20 stops power operation means that the power switch of the front stage circuit 20 stops switching so that the energy transmission from the input terminals to the output terminals stops.

The switch control circuit 25 is coupled to the output terminal of the voltage sensing circuit 24 to receive the voltage sensing signal Vsen and configured to generate the switch control signal P1 to control the front stage circuit 20 based on the voltage sensing signal Vsen. In the example shown FIG. 2, the switch control circuit 25 is further coupled to the pin CS to receive the second voltage signal Vcs and configured to generate the switch control signal P1 based on the voltage sensing signal Vsen and the second voltage signal Vcs. In one embodiment, when the second voltage signal Vcs decreases to a threshold voltage, the switch control circuit 25 is configured to turn off a power switch of the front stage circuit 20.

In the example shown in FIG. 2, the front stage circuit 20 and the rear stage circuit 23 can share the same voltage dividing circuit 21 to sense voltage. This can reduce the power loss of the switching converter 200 effectively.

In the example shown in FIG. 2, other circuits are not shown for clarity. Those skilled in the art can understand that the integrated control circuit IC1 may include other circuits, such as over current protection circuit, over voltage protection circuit and so on.

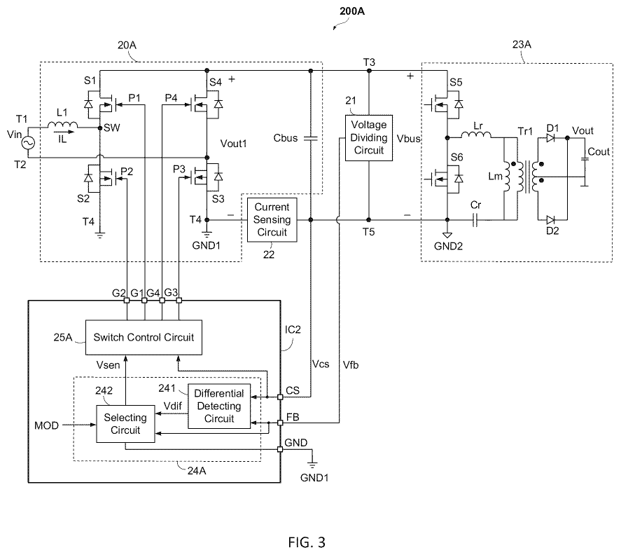

FIG. 3 illustrates a circuit schematic of a switching converter 200A in accordance with an embodiment of the present invention. The switching converter 200A includes a front stage circuit 20A, the voltage dividing circuit 21 and the current sensing circuit 22. As shown in FIG. 3, the front stage circuit 20A is a totem pole power factor correction (PFC) circuit having an inductor L1, power switches S1^{˜}S4 and a capacitor Cbus. The inductor L1 is coupled between the node T1 and a node SW. The first power switch S1 is coupled between the node T3 and the node SW. The second power switch S2 is coupled between the node SW and the node T4. The third power switch S3 is coupled between the node T2 and the node T4. The fourth power switch S4 is coupled between the node T3 and the node T2. The capacitor Cbus is coupled between the node T3 and the node T4. The front stage circuit 20A is configured to receive the input voltage Vin between the node T1 and the node T2 and to generate the first output voltage Vout1 between the node T3 and the node T4 via the turning-on and the turning-off of the power switches S1^{˜}S4, where the node T4 is coupled to the reference ground GND1 of the front stage circuit 20A.

The voltage dividing circuit 21 is coupled between the node T3 and the node T5 and configured to generate the first voltage signal Vfb at the output terminal. The current sensing circuit 22 is coupled between the node T5 and the node T4 and configured to generate the second voltage signal Vcs at the node T5.

In the example shown in FIG. 3, the second voltage signal Vcs represents a current IL flowing through the inductor L1 of the front stage circuit 20A, more specifically, represents the decreasing part of the current IL.

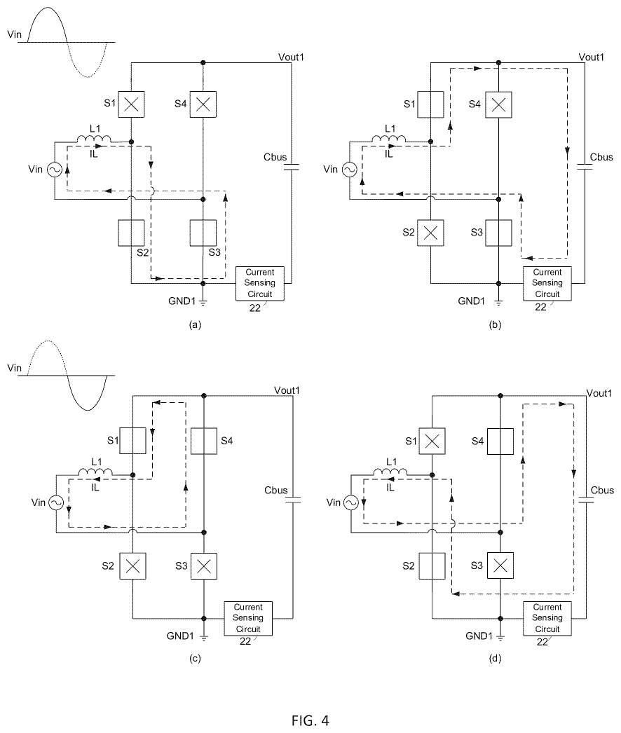

FIG. 4 illustrates working states of the power switches S1^{˜}S4 in the front stage circuit 20A shown in FIG. 3 in accordance with an embodiment of the present invention. Where FIG. 4(a) and FIG. 4(b) show working states of the power switches S1^{˜}S4 when the input voltage Vin is in a positive half cycle, FIG. 4(c) and FIG. 4(d) show working states of the power switches S1^{˜}S4 when the input voltage Vin is in a negative half cycle.

When the input voltage Vin is in the positive half cycle, as shown in FIG. 4(a) and FIG. 4(b), the third power switch S3 keeps ON, the fourth power switch S4 keeps OFF, the first power switch S1 and the second power switch S2 switch between ON and OFF. In FIG. 4(a), the first power switch S1 is turned OFF and the second power switch S2 is turned ON, the current IL increases and flows successively through the inductor L1, the second power switch S2 and the third power switch S3. In FIG. 4(b), the first power switch S1 is turned ON and the second power switch S2 is turned OFF, the current IL decreases and flows successively through the inductor L1, the first power switch S1, the capacitor Cbus, the current sensing circuit 22 and the third power switch S3.

When the input voltage Vin is in the negative half cycle, as shown in FIG. 4(c) and FIG. 4(d), the third power switch S3 keeps OFF, the fourth power switch S4 keeps ON, the first power switch S1 and the second power switch S2 switch between ON and OFF. In FIG. 4(c), the first power switch S1 is turned ON and the second power switch S2 is turned OFF, the current IL increases and flows successively through the fourth power switch S4, the first power switch S1 and the inductor L1. In FIG. 4(d), the first power switch S1 is turned OFF and the second power switch S2 is turned ON, the current IL decreases and flows successively through the fourth power switch S4, the capacitor Cbus, the current sensing circuit 22, the second power switch S2 and the inductor L1.

When the current IL decreases as shown in FIG. 4(b) and FIG. 4(d), the current IL flows through the current sensing circuit 22 and thus the second voltage signal Vcs represents the decreasing part of the current IL.

Continue referring to FIG. 3, the switching converter 200A further includes a voltage sensing circuit 24A and a switch control circuit 25A, where the voltage sensing circuit 24A and the switch control circuit 25A are integrated in an integrated control circuit IC2. The integrated control circuit IC2 has a plurality of pins, including a pin FB for receiving feedback voltage information, a pin CS for receiving current information, pins G1^{˜}G4 for providing switch control signals P1^{˜}P4 to the front stage circuit 20A and a pin GND. The pin FB is coupled to the output terminal of the voltage dividing circuit 21 to receive the first voltage signal Vfb. The pin CS is coupled to the node T5 to receive the second voltage signal Vcs. The pin GND is coupled to the reference ground GND1 of the front stage circuit 20A.

The voltage sensing circuit 24A includes a differential detecting circuit 241 and a selecting circuit 242. The differential detecting circuit 241 has a first input terminal, a second input terminal and an output terminal, where the first input terminal is coupled to the pin FB to receive the first voltage signal Vfb and the second input terminal is coupled to the pin CS to receive the second voltage signal Vcs. Based on the difference between the first voltage signal Vfb and the second voltage signal Vcs, the differential detecting circuit 241 generates a differential voltage signal Vdif at the output terminal.

The selecting circuit 242 has a first input terminal, a second input terminal, a control terminal, a reference ground terminal and an output terminal, where the first input terminal is coupled to output terminal of the differential detecting circuit 241, the second input terminal is coupled to the pin FB, the control terminal receives a mode signal MOD indicating whether the front stage circuit 20A performs power operation and the reference ground terminal is coupled to the pin GND. Based on the differential voltage signal Vdif, the first voltage signal Vfb and the mode signal MOD, the selecting circuit 242 generates the voltage sensing signal Vsen at the output terminal.

In one embodiment, when the front stage circuit 20A performs power operation, the mode signal MOD is in a first level, the selecting circuit 242 provides the differential voltage signal Vdif as the voltage sensing signal Vsen; when the front stage circuit 20A stops power operation, the mode signal MOD is in a second level, the selecting circuit 242 provides the voltage sensing signal Vsen based on the difference between the first voltage signal Vfb and the reference ground GND1.

In one embodiment, the front stage circuit 20A performs power operation means that the power switches S1^{˜}S4 perform switching as shown in FIG. 4.

In one embodiment, the front stage circuit 20A stops power operation means that the first power switch S1 and the second power switch S2 stop switching (e.g., both the first power switch S1 and the second power switch S2 keep OFF). In another embodiment, the front stage circuit 20A stops power operation means that all power switches S1^{˜}S4 keep OFF.

The switch control circuit 25A is coupled to the voltage sensing circuit 24A to receive the voltage sensing signal Vsen and coupled to the pin CS to receive the second voltage signal Vcs. The switch control circuit 25A is configured to generate the switch control signals P1^{˜}P4 to control the front stage circuit 20A based on the voltage sensing signal Vsen and the second voltage signal Vcs.

In the example shown in FIG. 3, the switching converter 200A further includes a rear stage circuit 23A. The rear stage circuit 23A is coupled between the node T3 and the node T5 to receive the bus voltage Vbus and configured to convert the bus voltage Vbus into the second output voltage Vout. In the example shown in FIG. 3, the rear stage circuit 23A is a LLC resonant converting circuit, including power switches S5^{˜}S6, a resonant inductor Lr, a resonant capacitor Cr, a transformer Tr1, diodes D1^{˜}D2 and a capacitor Cout, connected as shown in FIG. 3.

Those skilled in the art can understand that the totem pole PFC circuit and the LLC resonant converting circuit in the example shown in FIG. 3 are used for illustration, not used for limiting the present invention. Other suitable circuits are also applicable here. In other embodiments, the rear stage circuit may be BUCK, BOOST, Flyback converter and so on. In addition, the power switches in the embodiments of the present invention may be any controllable semiconductor device, such as BJT, JFET, MOSFET, IGBT, GaNFET and so on.

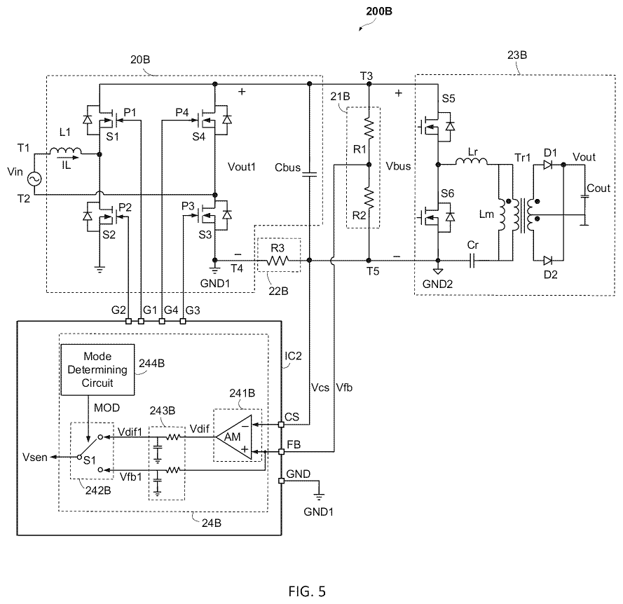

FIG. 5 illustrates a circuit schematic of a switching converter 200B in accordance with another embodiment of the present invention. The switching converter 200B includes a front stage circuit 20B, a voltage dividing circuit 21B, a current sensing circuit 22B, a rear stage circuit 23B and a voltage sensing circuit 24B. Different from FIG. 3, the voltage dividing circuit 21B shown in FIG. 5 includes a first resistor R1 and a second resistor R2 coupled in series, where a common connection node of the first resistor R1 and the second resistor R2 is the output terminal of the voltage dividing circuit 21B. The current sensing circuit 22B shown in FIG. 5 includes a third resistor R3. In one embodiment, the resistance of the first resistor R1 is about 10 MΩ, the resistance of the second resistor R2 is about 3 KΩ and the resistance of the third resistor R3 is about 50 mΩ.

In one embodiment, the rear stage circuit 23B is coupled to the output terminal of the voltage dividing circuit 21B to receive the first voltage signal Vfb and configured to sense the bus voltage Vbus based on the difference between the first voltage signal Vfb and the voltage at the node T5. In a further embodiment, the rear stage circuit 23B obtains a voltage Vsen2 indicative of the difference between the first voltage signal Vfb and the voltage at node T5, then the bus voltage Vbus=Vsen2/k, where k=R2/(R1+R2).

Those skilled in the art can understand that the voltage dividing circuit 21B and the current sensing circuit 22B are only used for exemplary illustration, other suitable circuits are also applicable here. In one embodiment, the voltage dividing circuit 21 and/or the current sensing circuit 22 may include more resistors. In another embodiment, the resistors of the voltage dividing circuit 21B and/or the current sensing circuit 22B may be replaced by transistors.

In the example shown in FIG. 5, the voltage sensing circuit 24B includes a differential detecting circuit 241B, a selecting circuit 242B and a filtering circuit 243B. The differential detecting circuit 241B includes an amplifier AM. The amplifier AM has a first input terminal, a second input terminal and an output terminal, where the first input terminal receives the first voltage signal Vfb and the second input terminal receives the second voltage signal Vcs. Based on the difference between the first voltage signal Vfb and the second voltage signal Vcs, the amplifier AM generates the differential voltage signal Vdif at the output terminal. The filtering circuit 243B receives the first voltage signal Vfb and the differential voltage signal Vdif and filters out the noise of the first voltage signal Vfb and the differential voltage signal Vdif respectively to generate a first filtering voltage signal Vfb1 and a differential filtering voltage signal Vdif1.

The selecting circuit 242B includes a multiplexer S1. The multiplexer S1 has a first terminal, a second terminal, a control terminal and an output terminal, where the first terminal receives the differential filtering voltage signal Vdif1, the second terminal receives the first filtering voltage signal Vfb1 and the control terminal receives the mode signal MOD. In one embodiment, when the front stage circuit 20B performs power operation, the mode signal MOD is in the first level, the multiplexer S1 couples the output terminal to the first terminal, thereby providing the differential filtering voltage signal Vdif1 as the voltage sensing signal Vsen; when the front stage circuit 20B stops power operation, the mode signal MOD is in the second level, the multiplexer S1 couples the output terminal to the second terminal, thereby providing the first filtering voltage signal Vfb1 as the voltage sensing signal Vsen. In one embodiment, when the front stage circuit 20B stops power operation, the amplifier AM is disabled to further reduce the power loss of the switching converter 200B. In other embodiments, the filtering circuit 243B may be coupled between the output terminal of the selecting circuit 242B and the reference ground GND1 to filter out the noise of the voltage sensing signal Vsen.

In the example shown in FIG. 5, the voltage sensing circuit 24B further includes a mode determining circuit 244B for providing the mode signal MOD. In one embodiment, the mode determining circuit 244B receives the switch control signals P1^{˜}P4 and determines whether the front stage circuit 20B performs power operation based on the switch control signals P1^{˜}P4. In a further embodiment, when the switch control signals P1^{˜}P4 switch between logic high and logic low, the mode signal MOD is in the first level indicating that the front stage circuit 20B performs power operation; when the switch control signals P1^{˜}P4 keep logic low, the mode signal MOD is in the second level indicating that the front stage circuit 20B stops power operation. In another embodiment, the mode determining circuit 244B receives the voltage sensing signal Vsen indicative of the first output voltage Vout1 and determines whether the front stage circuit 20B performs power operation by comparing the voltage sensing signal Vsen with a first threshold voltage Vth1 and a second threshold voltage Vth2 respectively. In a further embodiment, when the voltage sensing signal Vsen increases to the first voltage threshold Vth1, the mode signal MOD is in the second level indicating that the front stage circuit 20B stops power operation; when the voltage sensing signal Vsen decreases to the second voltage threshold Vth2, the mode signal MOD is in the first level indicating that the front stage circuit 20B performs power operation.

Those skilled in the art can understand that the examples shown above are used for illustrative purposes, not used for limiting the present invention. Other suitable circuits can also be applicable here. For example, the working principle of the voltage sensing circuit 24 can be described by digital language such as VHDL, Verilog, thereby generating digital circuits to realize the functions of the voltage sensing circuit 24.

According to the embodiments of the present invention, when the front stage circuit 20 performs power operation, the front stage circuit 20 senses the first output voltage Vou1 between the node T3 and the node T4 by the voltage dividing circuit 21 and the current sensing circuit 22; when the front stage circuit 20 stops power operation, there is no current flowing through the current sensing circuit 22 and the front stage circuit 20 can sense the first output voltage Vout1 by the voltage dividing circuit 21 directly. In one embodiment, the first output voltage Vout1=Vsen/d, where Vsen is the voltage sensing signal provided by the voltage sensing circuit 24, and d is a proportional coefficient. In one embodiment, d=0.0032.

At the same time, the rear stage circuit 23 can sense the bus voltage Vbus between the node T3 and the node T5 by the voltage dividing circuit 21 regardless of whether the front stage circuit 20 performs power operation or not.

Therefore, the front stage circuit 20 and the rear stage circuit 23 can share the same voltage dividing circuit 21 to sense voltage. This can reduce the power loss of the switching converter 200.

In addition, when the front stage circuit 20 stops power operation, the differential detecting circuit 241 can be disabled to further reduce the power loss.

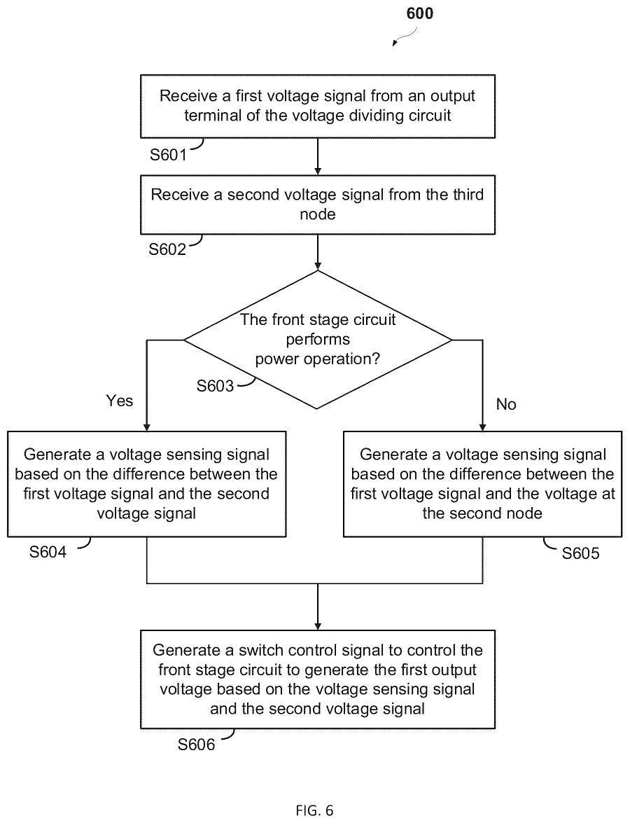

FIG. 6 illustrates a flowchart of a control method 600 used in a switching converter in accordance with an embodiment of the preset invention. The switching converter includes a front stage circuit generating a first output voltage between a first node and a second node, a voltage dividing circuit coupled between the first node and a third node, a current sensing circuit coupled between the third node and the second node and a rear stage circuit coupled between the first node and the third node to receive a bus voltage. The control method 600 includes steps S601^{˜}S606.

At step S601, a first voltage signal is received from an output terminal of the voltage dividing circuit.

At step S602, a second voltage signal is received from the third node.

At step S603, whether the front stage circuit performs power operation is determined. If the front stage circuit performs power operation, go to step S604; if the front stage circuit stops power operation, go to step S605.

At step S604, a voltage sensing signal is generated based on the difference between the first voltage signal and the second voltage signal.

At step S605, a voltage sensing signal is generated based on the difference between the first voltage signal and the voltage at the second node.

At step S606, a switch control signal is generated to control the front stage circuit to generate the first output voltage based on the voltage sensing signal and the second voltage signal.

Those skilled in the art can understand that, in the flowchart described above, the steps may also be performed in an order different from the order shown as FIG. 6. For example, two successive steps may be performed meanwhile, or may be performed in a reverse order sometimes, it depends to the specific function involved.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A switching converter comprising:
a front stage circuit configured to generate a first output voltage between a first node and a second node;
a voltage dividing circuit coupled between the first node and a third node and configured to generate a first voltage signal at an output terminal of the voltage dividing circuit;
a current sensing circuit coupled between the third node and the second node;
a rear stage circuit coupled between the first node and the third node to receive a bus voltage and configured to convert the bus voltage into a second output voltage; and
a voltage sensing circuit coupled to the output terminal of the voltage dividing circuit to receive the first voltage signal and coupled to the third node to receive a second voltage signal, wherein the voltage sensing circuit is configured to generate a voltage sensing signal indicative of the first output voltage based on the first voltage signal and the second voltage signal.

2. The switching converter of claim 1, wherein:
when the front stage circuit performs power operation, the voltage sensing circuit is configured to generate the voltage sensing signal based on the difference between the first voltage signal and the second voltage signal; and
when the front stage circuit stops power operation, the voltage sensing circuit is configured to generate the voltage sensing signal based on the difference between the first voltage signal and the voltage at the second node.

3. The switching converter of claim 2, wherein the voltage sensing circuit comprises:
a differential detecting circuit having a first input terminal, a second input terminal and an output terminal, wherein the first input terminal is configured to receive the first voltage signal and the second input terminal is configured to receive the second voltage signal, the differential detecting circuit is configured to generate a differential voltage signal at the output terminal based on the difference between the first voltage signal and the second voltage signal; and
a selecting circuit having a first input terminal, a second input terminal, a control terminal and an output terminal, wherein the first input terminal is configured to receive the differential voltage signal, the second input terminal is configured to receive the first voltage signal and the control terminal is configured to receive a mode signal indicating whether the front stage circuit performs power operation, the selecting circuit is configured to generate the voltage sensing signal at the output terminal based on the differential voltage signal, the first voltage signal and the mode signal.

4. The switching converter of claim 1, wherein the front stage circuit comprises a totem pole PFC (power factor correction) circuit.

5. The switching converter of claim 4, wherein the second voltage signal represents a current flowing through an inductor of the totem pole PFC circuit.

6. The switching converter of claim 1, wherein the rear stage circuit is configured to sense the bus voltage based on the difference between the first voltage signal and the voltage at the third node.

7. The switching converter of claim 6, wherein the rear stage circuit comprises a LLC resonant converting circuit.

8. The switching converter of claim 1, wherein the voltage sensing circuit is integrated in an integrated control circuit, wherein the output terminal of the voltage dividing circuit is coupled to a first pin of the integrated control circuit and the third node is coupled to a second pin of the integrated control circuit.

9. The switching converter of claim 1, further comprising:
a switch control circuit configured to receive the voltage sensing signal and the second voltage signal and to generate a switch control signal to control the front stage circuit based on the voltage sensing signal and the second voltage signal.

10. A control circuit for a switching converter with a front stage circuit providing a first output voltage between a first node and a second node, a voltage dividing circuit coupled between the first node and a third node and a current sensing circuit coupled between the third node and the second node, the control circuit comprising:
a first pin configured to be coupled to an output terminal of the voltage dividing circuit to receive a first voltage signal;
a second pin configured to be coupled to the third node to receive a second voltage signal;
a third pin configured to provide a switch control signal to control the front stage circuit;
a fourth pin configured to be coupled to the second node and coupled to a reference ground of the control circuit;
a voltage sensing circuit coupled to the first pin to receive the first voltage signal, coupled to the second pin to receive the second voltage signal and coupled to the fourth pin, wherein the voltage sensing circuit is configured to generate a voltage sensing signal indicative of the first output voltage based on the first voltage signal and the second voltage signal; and
a switch control circuit configured to receive the voltage sensing signal and the second voltage signal and to generate the switch control signal based on the voltage sensing signal and the second voltage signal.

11. The control circuit of claim 10, wherein:
when the front stage circuit performs power operation, the voltage sensing circuit is configured to generate the voltage sensing signal based on the difference between the first voltage signal and the second voltage signal; and
when the front stage circuit stops power operation, the voltage sensing circuit is configured to generate the voltage sensing signal based on the first voltage signal.

12. The control circuit of claim 11, wherein the voltage sensing circuit comprises:
a differential detecting circuit having a first input terminal, a second input terminal and an output terminal, wherein the first input terminal is configured to receive the first voltage signal and the second input terminal is configured to receive the second voltage signal, the differential detecting circuit is configured to generate a differential voltage signal at the output terminal based on the difference between the first voltage signal and the second voltage signal; and
a selecting circuit having a first input terminal, a second input terminal, a control terminal and an output terminal, wherein the first input terminal is coupled to the output terminal of the differential detecting circuit, the second input terminal is coupled to the first pin and the control terminal is configured to receive a mode signal indicating whether the front stage circuit performs power operation, the selecting circuit is configured to generate the voltage sensing signal at the output terminal based on the differential voltage signal, the first voltage signal and the mode signal.

13. The control circuit of claim 12, wherein when the front stage circuit stops power operation, the differential detecting circuit is configured to be disabled.

14. The control circuit of claim 12, wherein the voltage sensing circuit further comprises:
a mode determining circuit configured to generate the mode signal based on the switch control signal or the voltage sensing signal.

15. The control circuit of claim 12, wherein the voltage sensing circuit further comprises:
a filtering circuit configured to filter out the noise of the differential voltage signal and the first voltage signal respectively to generate a differential filtering voltage signal and a first filtering voltage signal; wherein
the selecting circuit is configured to generate the voltage sensing signal based on the differential filtering voltage signal, the first filtering voltage signal and the mode signal.

16. The control circuit of claim 10, wherein the switching converter further comprises a rear stage circuit coupled between the first node and the third node to receive a bus voltage, the rear stage circuit is configured to sense the bus voltage based on the difference between the first voltage signal and the voltage at the third node.

17. The control circuit of claim 16, wherein the rear stage circuit comprises a LLC resonant converting circuit.

18. The control circuit of claim 10, wherein the front stage circuit comprises a totem pole PFC circuit and the second voltage signal represents a current flowing through an inductor of the totem pole PFC circuit.

19. A control method for a switching converter with a front stage circuit providing a first output voltage between a first node and a second node, a voltage dividing circuit coupled between the first node and a third node and a current sensing circuit coupled between the third node and the second node, the control method comprising:
receiving a first voltage signal from an output terminal of the voltage dividing circuit;
receiving a second voltage signal from the third node;
generating a voltage sensing signal indicative of the first output voltage based on the first voltage signal and the second voltage signal; and
generating a switch control signal to control the front stage circuit based on the voltage sensing signal and the second voltage signal.

20. The control method of claim 19, wherein the step of generating the voltage sensing signal comprises:
generating the voltage sensing signal based on the difference between the first voltage signal and the second voltage signal when the front stage circuit performs power operation; and
generating the voltage sensing signal based on the difference between the first voltage signal and the voltage at the second node when the front stage circuit stops power operation.
